(19) United States
(12) Patent Application Publication
(10) Pub. No.: US 2024/0304829 A1
(43) Pub. Date: Sep. 12, 2024

(54) ELECTRODE FOR FUEL CELL COMPRISING NON-PLATINUM CATALYST AND GRAPHENE LAYERED STRUCTURE, AND MEMBRANE-ELECTRODE ASSEMBLY COMPRISING SAME

(71) Applicant: KOLON INDUSTRIES, INC., Seoul (KR)

(72) Inventors: Hyeong Su KIM, Seoul (KR); Jun Young KIM, Seoul (KR); Nak Won KONG, Seoul (KR); Jung Ho KIM, Seoul (KR); Ju Sung LEE, Seoul (KR); Chan Mi PARK, Seoul (KR)

(21) Appl. No.: 18/260,400

(22) PCT Filed: Aug. 5, 2022
(86) PCT No.: PCT/KR2022/011709

§ 371 Date: Jul. 5, 2023

(30) Foreign Application Priority Data
Aug. 13, 2021 (KR) 10-2021-0107386
Aug. 4, 2022 (KR) 10-2022-0097439

(51) Int. Cl. H01M 4/90; H01M 4/86; H01M 4/88; H01M 4/96

(52) U.S. Cl. CPC H01M 4/9041; H01M 4/8657; H01M 4/881; H01M 4/8882; H01M 4/8892; H01M 4/9008; H01M 4/9083; H01M 4/96; H01M 2004/8689

(57) ABSTRACT

The present invention relates to an electrode for a fuel cell, comprising a non-platinum catalyst and a graphene layered structure, and a membrane-electrode assembly comprising the same and, more specifically, to a membrane-electrode assembly for a fuel cell and a fuel cell comprising the same, which implement excellent electrode efficiency through relatively inexpensive transition metals while not using platinum, by stacking alternately with a graphene layer, a catalyst layer comprising both a non-platinum catalyst complex including a carbon support, nitrogen, and non-platinum transition metal, and a conductive polymer.

### TECHNICAL FIELD

The present disclosure relates to a fuel cell electrode which has improved performance and durability while using expensive platinum, and a membrane-electrode assembly including the same.

### BACKGROUND ART

A fuel cell is a battery equipped with a power generation system that directly converts chemical reaction energy in reactions such as an oxidation/reduction reaction of hydrogen and oxygen contained in hydrocarbon-based fuel materials such as methanol, ethanol, and natural gas into electrical energy, and is spotlighted as a next-generation clean energy source that can replace fossil energy due to its high energy efficiency and eco-friendly characteristics with low pollutant emissions.

Such a fuel cell has the advantage of being able to produce a wide range of outputs in a stack configuration by stacking unit cells, and it is attracting attention as a small and mobile portable power source since it shows an energy density 4 to 10 times that of a small lithium battery.

A stack that actually generates electricity in a fuel cell has a structure in which several to dozens of unit cells composed of a membrane-electrode assembly (MEA) and a separator (or called a bipolar plate also) are stacked, and the membrane-electrode assembly generally has a structure in which an oxidizing electrode (anode or fuel electrode) and a reducing electrode (cathode or air electrode) are respectively formed on both sides of an electrolyte membrane interposed therebetween.

Fuel cells may be classified into alkaline electrolyte fuel cells, polymer electrolyte membrane fuel cells (PEMFC), etc. depending on the state and type of electrolyte, and the polymer electrolyte membrane fuel cells among them are spotlighted as a portable vehicle and home power supply due to its advantages such as a low operating temperature of less than 100° C., fast start-up and response characteristics, and excellent durability.

Typical examples of the polymer electrolyte membrane fuel cells may include a proton exchange membrane fuel cell (PEMFC) that uses hydrogen gas as fuel, a direct methanol fuel cell (DMFC) that uses liquid methanol as fuel, etc.

Conventionally, a polymer electrolyte membrane fuel cell (PEMFC) and a membrane-electrode assembly (MEA) are composed of an anode electrode, a cathode electrode, and a polymer electrolyte membrane (PEM) disposed between the anode and cathode electrodes. The oxidation reaction of fuel occurs at the anode electrode to which hydrogen or fuel is supplied, the hydrogen ions generated at the anode electrode are conducted to the cathode electrode through the electrolyte membrane, and the reduction reaction of oxygen occurs at the cathode electrode to which oxygen is supplied, thereby generating a voltage difference between the two electrodes so that electricity is generated.

The anode electrode of the fuel cell includes a catalyst for promoting a reaction for generating hydrogen ions by oxidizing fuel, and the cathode electrode includes a catalyst for promoting reduction of oxygen. A fuel cell catalyst mainly consists of catalytic metal particles and a carrier having high electrical conductivity for uniformly dispersing them. In general, catalysts containing platinum (Pt) as an active component are used as components of anode and cathode electrodes.

However, platinum-based catalysts account for a large portion of the total fuel cell production cost due to their low reserves and high price, thereby becoming an obstacle limiting mass production and commercialization of fuel cells. In particular, PEMFCs of platinum-based catalysts mainly use platinum for both the anode and the cathode, and these catalysts account for an extent corresponding to 40 to 50% of the total cost of the PEMFC stack. Therefore, there is an urgent need to develop a non-noble metal-based catalyst that can replace platinum.

### DISCLOSURE

### Technical Problem

An object of the present disclosure is to provide a fuel cell electrode which has excellent efficiency without using a platinum-based catalyst.

Another object of the present disclosure is to provide a method for manufacturing the fuel cell electrode described above.

Another object of the present disclosure is to provide a membrane-electrode assembly having excellent efficiency without using platinum by including the fuel cell electrode.

Another object of the present disclosure is to provide a fuel cell in which the membrane-electrode assembly is included so that platinum is not contained.

### Technical Solution

In order to achieve the above object, a fuel cell electrode according to one aspect of the present disclosure includes: a catalyst layer including a non-platinum catalyst complex and a conductive polymer; and a graphene layer made of one or more of graphene and graphene oxide, wherein the catalyst layer and the graphene layer are alternately stacked. In this case, the non-platinum catalyst complex includes a carbon support, and a non-platinum transition metal and nitrogen which are formed on the carbon support, and specifically, the non-platinum catalyst complex may have an active site which is formed by a coordination bond between the non-platinum transition metal and nitrogen and exists therein.

The catalyst layer may have a form in which the conductive polymer is coated on the surface of the non-platinum catalyst complex.

The non-platinum catalyst complex may be prepared by mixing the carbon support and an M-N precursor containing a non-platinum transition metal (M) and nitrogen (N) at a mass ratio of 1:1 to 1:5.

The non-platinum catalyst complex and the conductive polymer may be included in the catalyst layer at a mass ratio of 1:20 to 5:1.

The non-platinum catalyst complex may be formed from an M-N precursor, and the M-N precursor may include a nitrogen-containing macrocyclic compound including a metal-nitrogen coordination, and the nitrogen-containing macrocyclic compound including a metal-nitrogen coordination may include, for example, one or more of porphyrin, phthalocyanine, corrole, cyclam, tetraazaannulene, and derivatives thereof. In addition, the M-N precursor may include the non-platinum transition metal, and may include one or more of Fe, Co, and Mn.

The carbon support may include one or more from the group consisting of carbon black, graphene, graphene oxide, carbon nanofibers, and carbon nanotubes.

The conductive polymer may include one or more of polyacetylene, polypyrrole, polyaniline, polythiophene, and perfluorosulfonic acid.

The catalyst layer may have a thickness of 1 to 200 nm.

The catalyst layer and the graphene layer may have a multilayer structure of 3 to 200 layers.

A membrane-electrode assembly for a fuel cell according to another aspect of the present disclosure includes the fuel cell electrode and a polymer electrolyte membrane.

At this time, the fuel cell electrode according to one aspect of the present disclosure may be applied to the cathode electrode.

A fuel cell according to another aspect of the present disclosure includes the membrane-electrode assembly for a fuel cell.

### Advantageous Effects

The fuel cell electrode of the present disclosure is a structure in which a catalyst layer and a graphene layer are stacked, and the catalyst layer can realize excellent electrode efficiency through a relatively inexpensive transition metal without using platinum as a catalyst.

Further, the conductive polymer used together in the catalyst layer can improve the efficiency of the non-platinum catalyst by limiting the size of the transition metal particles.

In addition, the graphene layer is alternately laminated with the catalyst layer, and the active point can be maximally exposed on the reaction surface through the multi-layer structure formed thereby, and the graphene layer can not only improve the conductivity of the electrode, but also improve performance and durability of the fuel cell by forming an empty space between the catalyst particles to provide a smooth material transfer passage during driving of the fuel cell.

### DESCRIPTION OF DRAWINGS

FIG. 1 is a schematic diagram briefly showing a laminated structure of an electrode according to one embodiment of the present disclosure.

FIG. 2 is a graph comparing performances of fuel cells including membrane-electrode assemblies according to Examples, Reference Example, and Comparative Example of the present disclosure.

FIG. 3 is a schematic diagram showing an overall configuration of the fuel cell.

### BEST MODE FOR CARRYING OUT THE INVENTION

Hereinafter, embodiments of the present disclosure will be described in detail with reference to the drawings so that those skilled in the art to which the present disclosure pertains can easily carry out the present disclosure. However, the present disclosure may be embodied in many different forms and is not limited to the embodiments described herein.

A fuel cell electrode according to one aspect of the present disclosure is characterized in that it has a structure in which a catalyst layer that does not contain expensive platinum (Pt), which is generally used in fuel cell electrodes, and a graphene layer including graphene are alternately stacked.

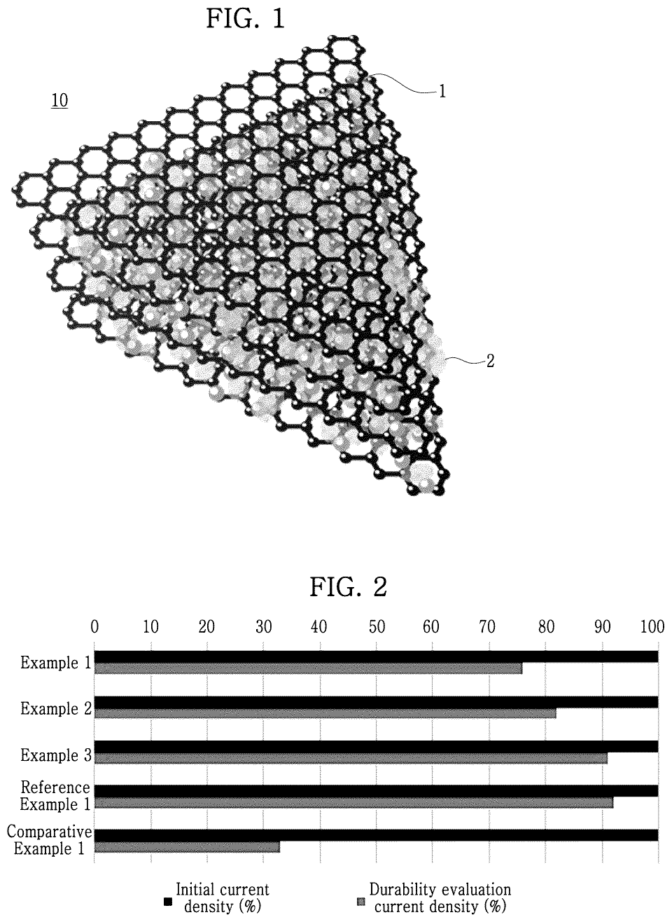

FIG. 1 is a schematic diagram briefly showing a laminated structure of an electrode 10 according to one embodiment of the present disclosure. Referring to FIG. 1, it may be a laminated structure in which the catalyst layer 2 and the graphene layer 1 exist in plurality in one electrode 10, and the catalyst layer 2 and the graphene layer 1 are alternately stacked.

The catalyst layer includes a non-platinum catalyst complex and a conductive polymer together instead of ones made from expensive platinum. The non-platinum catalyst complex includes a carbon support, and a non-platinum transition metal and nitrogen which are formed on the carbon support. Here, the metal catalyst is a non-platinum transition metal, meaning a transition metal except for platinum, and may preferably be a non-precious metal-based transition metal. In addition, the carbon support may include, for example, one or more of carbon black, graphene, graphene oxide, carbon nanofibers, and carbon nanotubes. In addition, nitrogen may be in a form which is included in a nitrogen-containing macrocyclic organic compound.

Specifically, the non-platinum catalyst complex forms an active site formed by a coordination bond between a non-platinum transition metal and nitrogen, and this can be expressed that an active site composed of an M (non-platinum transition metal)-Nx coordination is present. When heat treatment is performed at high temperatures for the preparation of an M-N—C-based electrode catalyst having a high oxygen reduction reaction level, large metal catalyst particles that cause performance degradation may be formed. In order to prevent this, a conductive polymer may be included in addition to the non-platinum catalyst complex, thereby limiting the size of the non-platinum transition metal and further improving the conductivity of the electrode.

The non-platinum catalyst complex may be coated with a conductive polymer, and specifically, it may be a form in which the conductive polymer is coated on the surface of the non-platinum catalyst complex through heat treatment after the conductive polymer covers the non-platinum catalyst complex.

The non-platinum catalyst complex is preferably prepared by mixing the carbon support and the M-N precursor containing the non-platinum transition metal (M) and nitrogen (N) at a mass ratio of 1:1 to 1:5. When the ratio of the carbon support is small compared to the above-described range, large metal catalyst particles that cause performance degradation may be formed when heat treatment is performed at high temperatures in order to form a non-platinum catalyst complex, and there may be a problem in that catalyst efficiency is lowered when the ratio of the carbon support is higher than the above-described range.

In the catalyst layer, the non-platinum catalyst complex and the conductive polymer are preferably included at a mass ratio of 1:20 to 5:1. In this case, the mass ratio may be independent of each of the plurality of catalyst layers in the electrode. When the mass ratio of the non-platinum catalyst complex is lower than the above-described mass ratio, the catalytic reaction may not occur smoothly in the electrode, and when the mass ratio of the conductive polymer is lower than the above-described mass ratio, the conductive polymer is lost in the heat treatment process, and catalytic activity and durability degradation may occur due to particle agglomeration of the transition metal exposed accordingly.

The non-platinum catalyst complex may be formed from an M-N precursor containing a non-platinum transition metal (M) and nitrogen (N), and in this case, the M-N precursor may include a nitrogen-containing macrocyclic organic compound including a metal-nitrogen coordination, and the nitrogen-containing macrocyclic organic compound including the metal-nitrogen coordination is not particularly limited as long as it can coordinately bond with the transition metal. The nitrogen-containing macrocyclic organic compounds including the metal-nitrogen coordination may include, for example, one or more of porphyrin, phthalocyanine, corrole, cyclam, tetraazaannulene, and derivatives thereof. In this case, tetraaza annulene may be specifically tetraaza[14]annulene.

The non-platinum transition metal of the M-N precursor is coordination-bonded with the macrocyclic organic compound to form an M-Nx site in the preparation process, and this will be an important configuration for realizing high activity of the non-platinum catalyst complex provided in the present disclosure. The type of transition metal is not particularly limited, and may preferably include one or more transition metals of Fe, Co, and Mn.

The conductive polymer may be any conductive polymer commonly used in fuel cells, and may preferably include one or more of polyacetylene, polypyrrole, polyaniline, polythiophene, and perfluorosulfonic acid.

Preferably, the catalyst layer including the non-platinum catalyst complex and the conductive polymer has a thickness of 1 to 200 nm. If the thickness of the catalyst layer is too thick or thin compared to the above-described range, the ability to supply fuel or discharge water in the electrode may deteriorate, and thus there may be a problem in that the efficiency of the fuel cell decreases. In addition, the plurality of catalyst layers in the electrode may each independently have a thickness within the above-described thickness range.

In the graphene layer, each of the plurality of graphene layers in the electrode may independently include one or more of graphene and graphene oxide. When the fuel cell electrode of the present disclosure is used in the cathode electrode, in order to discharge water generated by driving of the fuel cell and maintain the wetness of the electrolyte membrane side, the graphene layer of the polymer electrolyte membrane layer in the cathode electrode may be made of hydrophilic graphene oxide for maintenance of the wettability of the electrolyte membrane, and may be made of water-repellent graphene for smooth discharge of water to the opposite side.

The fuel cell electrode is a structure in which a plurality of catalyst layers and a plurality of graphene layers are stacked, and may be preferably a structure in which the catalyst layers and the graphene layers are alternately stacked.

At this time, the total number of layers of the catalyst layer and the graphene layer in the electrode is not particularly limited as long as it is three or more layers, but since the thickness of the electrode in which the catalyst layer and the graphene layer are excessively stacked may become excessively thick, it is preferable to form it as a multilayer structure of within 200 layers. That is, the total number of layers of the catalyst layer and the graphene layer may be 3 to 200 layers, for example, 10 to 200 layers, 50 to 150 layers, and the like. According to one embodiment, when the total number of layers of the catalyst layer and the graphene layer is three layers, it may be a structure which stacked in the order of the catalyst layer-graphene layer-catalyst layer, but is not limited to the above example. In addition, as another example, the stacked structure may be formed by repeating the pattern two or more times in the order of catalyst layer-graphene layer-catalyst layer-graphene oxide layer. Here, the graphene layer may be a layer formed of a single layer of graphene or a layer formed of two or more layers of graphene.

According to the present disclosure, the catalytic active point may be maximally exposed to the reaction surface by the multi-layered structure of the catalyst layer and the graphene layer, and accordingly, the catalytic efficiency may be improved so that the electrode performance may become excellent.

In addition, according to the present disclosure, the space may be formed between the catalyst layer and the graphene layer that have been stacked. Through the space, materials such as oxygen as a reactant and water as a product in the catalyst layer may be smoothly transferred and moved. According to one embodiment of the present disclosure, the space may have a pore structure. Here, the volume of the space, specifically, the porosity may be in a range of about 0.1 to about 95% by volume. In addition, according to one embodiment of the present disclosure, the space may or may not be partially or completely filled with an ionomer described later.

The catalyst layer may include an ionomer. According to one embodiment, the ionomer may fill at least a part of the space between the catalyst layer and the graphene layer.

The ionomer may include one or more ionomers selected from the group consisting of fluorine-based ionomers and hydrocarbon-based ionomers. The hydrocarbon-based ionomers may include all known hydrocarbon-based polymers, and may be, for example, sulfonated derivatives of poly(arylene ether)s (SPAEs), poly(arylene sulfide)s (SPASs), polyimides (SPIs), polybenzimidazoles (PBIs), polyphenylenes (PPs), and polyetheretherketone (PEEK). In addition, the fluorine-based ionomers may include all known fluorine-based polymers, and may be, for example, one of perfluorine-based sulfonic acid-based polymers such as Nafion, Aciplex, and Flemion, polyvinylidene fluoride, hexafluoropropylene, trifluoroethylene, polytetrafluoroethylene, or copolymers thereof.

A method for manufacturing a fuel cell electrode according to another aspect of the present disclosure may include the steps of: a) drying and heat-treating a dispersion containing a non-platinum catalyst complex and a conductive polymer to obtain a non-platinum catalyst complex coated with the conductive polymer; b) forming a graphene layer by applying a dispersion containing one or more of graphene and graphene oxide; c) forming a catalyst layer by applying a dispersion containing the non-platinum catalyst complex coated with the conductive polymer of the step a); and d) forming a multilayer structure in which the graphene layer and the catalyst layer are alternately stacked by repeating the steps b) and c) two or more times, respectively.

In the step a), the drying temperature and time may be appropriately adjusted by those skilled in the art in consideration of the content or the like of the dispersion solvent in the dispersion. Preferably, the drying may be performed at a temperature of 60 to 150° C., and coating of the conductive polymer on the non-platinum catalyst complex may be smoothly performed and a strong bond may be formed by setting the drying temperature within the above-described range.

In addition, the heat treatment temperature and time in the step a) may be appropriately adjusted by those skilled in the art in consideration of the type or the like of conductive polymer. Preferably, the heat treatment may be performed at a temperature of 300 to 900° C., and a bond between the non-platinum catalyst complex and the conductive polymer may be well formed by setting the heat treatment temperature within the above-described range.

In the step a), the non-platinum catalyst complex may be prepared by mixing the aforementioned carbon support, the non-platinum transition metal, and a nitrogen-containing organic compound. Therefore, according to one embodiment of the present disclosure, the method for manufacturing a fuel cell electrode may further include a step of preparing a non-platinum catalyst complex by mixing a carbon support, a non-platinum transition metal, and a nitrogen-containing organic compound. The types and mixing mass ratios of the carbon support, the non-platinum transition metal, and the nitrogen-containing organic compound are previously described. The non-platinum catalyst complex may be obtained in the form of a powder, and prior to the subsequent application step (step c)), it may be dispersed in a dispersion solvent to form a dispersion, and then applied in the application step.

The application method in the steps b) and c) is not particularly limited as long as the graphene or non-platinum catalyst complex may be well formed layer by layer. According to one embodiment of the present disclosure, the application may be preferably performed by ultrasonic spray. The ultrasonic spray is used, and thus materials such as graphene or non-platinum catalyst complexes may be uniformly and effectively sprayed and fixed, and the coating thickness may also be easily controlled. Conditions for the ultrasonic spray are not particularly limited, and the coating thickness and particle volume may be adjusted depending on the nozzle size, the solid concentration in the spray solution, the ultrasonic intensity, and the like. For example, the ultrasonic frequency range may be 100 to 300 kHz, and the larger the ultrasonic frequency range (kHz), the smaller the particle volume of the sprayed solution tends to be.

When stacking is performed in the step d), a space may be formed between the graphene layer and the catalyst layer. Regarding the space, reference is made to what has been previously described in relation to the electrode.

A membrane-electrode assembly for a fuel cell according to another aspect of the present disclosure includes the fuel cell electrode according to one embodiment of the present disclosure as one or more of a cathode electrode and an anode electrode, and includes a polymer electrolyte membrane. However, since the usability of the fuel cell may be further improved when the fuel cell electrode according to one aspect of the present disclosure that does not contain platinum is applied to a cathode electrode than when applied to an anode electrode, the fuel cell electrode according to one embodiment of the present disclosure is preferably included in the cathode electrode.

A fuel cell according to another aspect of the present disclosure may include the membrane-electrode assembly according to one embodiment of the present disclosure.

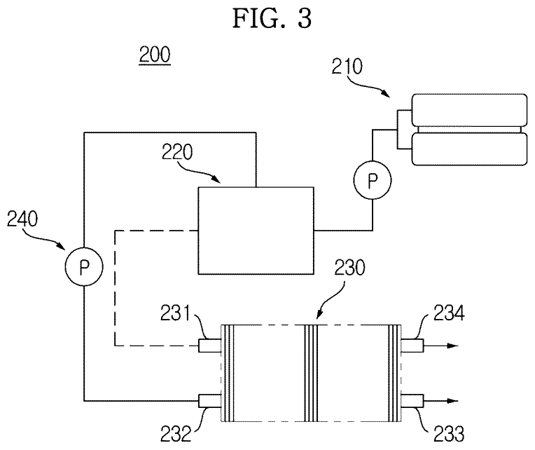

FIG. 3 is a schematic diagram showing an overall configuration of the fuel cell.

Referring to FIG. 3, the fuel cell 200 includes a fuel supply unit 210 for supplying mixed fuel in which fuel and water are mixed, a reforming unit 220 for generating reformed gas containing hydrogen gas by reforming the mixed fuel, a stack 230 which generates electrical energy by causing an electrochemical reaction between the reformed gas containing hydrogen gas supplied from the reforming unit 220 and an oxidizing agent, and an oxidizing agent supply unit 240 for supplying the oxidizing agent to the reforming unit 220 and the stack 230.

The stack 230 includes a plurality of unit cells generating electrical energy by inducing an oxidation/reduction reaction of a reformed gas containing hydrogen supplied from the reforming unit 220 and an oxidizing agent supplied from the oxidizing agent supply unit 240.

Each unit cell means a unit cell that generates electricity, and includes a membrane-electrode assembly for oxidizing/reducing oxygen in a hydrogen gas-containing reformed gas and an oxidizing agent, and separators (also called bipolar plates, hereinafter referred to as ‘separators’) for supplying the hydrogen gas-containing reformed gas and the oxidizing agent to the membrane-electrode assembly. The separators are placed on both sides of the membrane-electrode assembly which is located in the center therebetween. At this time, the separators respectively located on the outermost sides of the stack are particularly referred to as end plates.

One end plate of the separators includes a pipe-shaped first supply pipe 231 for injecting a reformed gas containing hydrogen gas supplied from the reforming unit 220 and a pipe-shaped second supply pipe 232 for injecting oxygen gas, and the other end plate thereof includes a first discharge pipe 233 for discharging a reformed gas containing hydrogen gas that has finally been unreacted in a plurality of unit cells and remain to the outside and a second discharge pipe 234 for discharging an oxidizing agent that has finally been unreacted in the above-described unit cells and remained to the outside.

In the fuel cell, since the separators, fuel supply unit, and oxidizing agent supply unit constituting the electricity generation unit are used in a conventional fuel cell that does not include the membrane-electrode assembly according to one embodiment of the present disclosure is used, detailed descriptions in this specification are omitted.

### MODE FOR CARRYING OUT THE INVENTION

Hereinafter, embodiments of the present disclosure will be described in detail so that those skilled in the art to which the present disclosure pertains can easily implement the present disclosure. However, the present disclosure may be embodied in many different forms and is not limited to the embodiments described herein.

### [Manufacturing Example: Manufacturing of Membrane-Electrode Assembly]

### Example 1

A non-platinum catalyst complex was prepared by mixing CNT as a carbon support and iron(III) phthalocyanine chloride as an Fe—N precursor (M-N precursor) at a mass ratio of 1:2. Then, a dispersion containing the prepared non-platinum catalyst complex and an aniline monomer at a mass ratio of 2:1 and using distilled water as a solvent was dried at 60° C. for 8 hours to obtain a solid powder.

The powder obtained through the drying was heat-treated at a temperature of 800° C. for 3 hours under a nitrogen atmosphere, and a catalyst dispersion was prepared from this using Nafion, a perfluorine-based sulfonic acid ionomer, distilled water, and normal-propyl alcohol.

In the ultrasonic spray, the graphene dispersion was injected into the first nozzle, and the catalyst dispersion was injected into the second nozzle.

After spraying and drying the first nozzle on a release material of fluorinated ethylene propylene (FEP) to form a graphene layer, the second nozzle was sprayed and dried on the formed graphene layer to form a catalyst layer, a graphene layer was formed on the formed catalyst layer in the same manner, an electrode layer was formed by alternately forming the catalyst layer and the graphene layer one by one in this way, and the total number of layers of the catalyst layer and the graphene layer in the electrode layer was 100 layers.

In the ultrasonic spray, the size of the mist may be controlled by adjusting the frequency of the dispersion, and in this embodiment, a mist having a size of about 10 μm was produced by applying an ultrasonic frequency of 180 KHz. The coating was performed under the conditions of a syringe pump flow rate of about 1 ml/min, a nozzle moving speed of 10 m/s, and an air pressure of 4 L/min.

A membrane-electrode assembly was manufactured by applying the formed electrode layer as a cathode electrode part and applying a Pt/C electrocatalyst as an anode electrode part and thermally compressing them to the polymer electrolyte membrane.

### Example 2

A membrane-electrode assembly was manufactured in the same manner except that the Fe—N precursor was changed to a Co—N precursor in Example 1.

### Example 3

A membrane-electrode assembly was manufactured in the same manner except that the Fe—N precursor was changed to an Mn—N precursor in Example 1.

### Experimental Example: Performance Comparison of Membrane-Electrode Assemblies

In order to compare the performances of Examples 1 to 3 manufactured in the above

Manufacturing Example, membrane-electrode assemblies were manufactured under the conditions as shown in Table 1 below by performing the cathode catalyst loading and anode catalyst loading on Reference Example 1 including an electrode including a platinum-based catalyst supported on a carbon support in the cathode electrode part according to the conventional technology and Comparative Example 1 including an electrode formed as a single layer of a dispersion in which the Fe—N precursor of the present disclosure, perfluorine-based sulfonic acid, and graphene are all mixed without a graphene layer and a catalyst layer being distinguished.

TABLE 1

| | Cathode catalyst loading | Anode catalyst loading |
|---|---|---|
| | (mg/cm²) | (mgPt/cm²) |
| Example 1 | 4.0 | 0.2 |
| Example 2 | 4.0 | 0.2 |
| Example 3 | 4.0 | 0.2 |
| Reference Example 1 | 0.8 | 0.2 |
| Comparative | 4.0 | 0.2 |
| Example 1 | | |

For Examples 1 to 3, Reference Example 1, and Comparative Example 1, the initial performances of the membrane-electrode assemblies under conditions of supplying the cathode fuel to oxygen or air were evaluated and shown in Table 2 below. Performance evaluation was performed under the conditions of a temperature of 65° C., an air pressure of 100 kPa, a relative humidity of 100%, and a hydrogen/air flow rate ratio of 1.5/2.0.

TABLE 2

| | Maximum power | Maximum power |
|---|---|---|
| | density mW/cm² | density mW/cm² |
| | (H₂/O₂) | (H₂/Air) |
| Example 1 | 1,000 | 660 |
| Example 2 | 920 | 575 |
| Example 3 | 880 | 515 |
| Reference Example 1 | 1,200 | 996 |
| Comparative | 520 | 260 |
| Example 1 | | |

The durability results of fuel cells including the membrane-electrode assemblies of Examples 1 to 3, Reference Example 1, and Comparative Example 1 manufactured in the configurations shown in Table 1 were compared and shown in FIG. 2. The graph of FIG. 2 compares the current density reduction levels before and after the durability evaluation for 100 hours at a constant voltage of 0.7 V under the same evaluation conditions as in Table 2.

Referring to Tables 1 and 2, the cathode catalyst loading values of the Examples which do not use platinum were shown to be higher than that of Reference Example 1 which uses a platinum catalyst, but when applied to a fuel cell, the maximum power densities of the Examples which do not use platinum did not show a significant difference compared to that of Reference Example 1 which uses the platinum catalyst. From this, it can be seen that the catalyst of the present disclosure can realize performance similar to that of one that uses platinum even without using platinum, which is an expensive rare metal.

Specifically, referring to Table 2 and FIG. 2, when comparing Examples 1 to 3 manufactured according to the present disclosure and Reference Example 1 manufactured using a conventional platinum-based catalyst, it can be seen that high levels of the oxygen reduction reaction (ORR) performance and durability similar to those of the platinum-based catalyst are shown.

In addition, when comparing Example 1 with Comparative Example 1 manufactured by mixing the same composition without layer distinction, Comparative Example 1 does not form a pore structure, whereas it can be seen that Example 1 shows excellent performance and durability in which the mass transfer of oxygen as a reactant and water as a product is smooth by exposing catalytically active sites to the reaction surface as much as possible through a multilayer structure and forming a pore structure at the same time.

In addition, through the comparison of Examples 1 to 3, it can be seen that the durability may be further improved depending on the selection of the M-N precursor.

Although the preferred embodiments of the present disclosure have been described in detail above, the scope of rights of the present disclosure is not limited thereto, and various modifications and improved forms of those skilled in the art using the basic concept of the present disclosure defined in the following claims also fall within the scope of the rights of the present disclosure.

### DESCRIPTION OF REFERENCE NUMERALS

1: Graphene layer
2: Catalyst layer
10: Electrode
200: Fuel cell
210: Fuel supply unit
220: Reforming unit
230: Stack
231: First supply pipe
232: Second supply pipe
233: First discharge pipe
234: Second discharge pipe
240: Oxidizing agent supply unit

1. A fuel cell electrode comprising:
a catalyst layer containing a non-platinum catalyst complex and a conductive polymer; and
a graphene layer made of one or more of graphene and graphene oxide,
wherein the catalyst layer and the graphene layer are alternately stacked, and
the non-platinum catalyst complex comprises a carbon support and a non-platinum transition metal and nitrogen which are formed on the carbon support.

2. The fuel cell electrode of claim 1, wherein the non-platinum catalyst complex has an active site which is formed by a coordination bond between the non-platinum transition metal and nitrogen and exists therein.

3. The fuel cell electrode of claim 1, wherein the conductive polymer is coated on the surface of the non-platinum catalyst complex.

4. The fuel cell electrode of claim 1, wherein the space is formed between the catalyst layer and the graphene layer that have been stacked.

5. The fuel cell electrode of claim 4, wherein the space has an ionomer filled in at least a part thereof.

6. The fuel cell electrode of claim 1, wherein the non-platinum catalyst complex is prepared by mixing the carbon support and an M-N precursor containing a non-platinum transition metal (M) and nitrogen (N) at a mass ratio of 1:1 to 1:5.

7. The fuel cell electrode of claim 1, wherein the non-platinum catalyst complex and the conductive polymer are contained in the catalyst layer at a mass ratio of 1:20 to 5:1.

8. The fuel cell electrode of claim 1, wherein the non-platinum catalyst complex is formed from a precursor comprising one or more of porphyrin, phthalocyanine, corrole, cyclam, tetraazaannulene, and derivatives thereof.

9. The fuel cell electrode of claim 1, wherein the non-platinum transition metal includes one or more of Fe, Co, and Mn.

10. The fuel cell electrode of claim 1, wherein the carbon support includes one or more of carbon black, graphene, graphene oxide, carbon nanofibers, and carbon nanotubes.

11. The fuel cell electrode of claim 1, wherein the conductive polymer includes one or more of polyacetylene, polypyrrole, polyaniline, polythiophene, and perfluorosulfonic acid.

12. The fuel cell electrode of claim 1, wherein the catalyst layer has a thickness of 1 to 200 nm.

13. The fuel cell electrode of claim 1, wherein the catalyst layer and the graphene layer have a multilayer structure of 3 to 200 layers.

14. A method for manufacturing a fuel cell electrode, the method comprising the steps of:
a) drying and heat-treating a dispersion containing a non-platinum catalyst complex and a conductive polymer to obtain a non-platinum catalyst complex coated with the conductive polymer;
b) forming a graphene layer by applying a dispersion containing one or more of graphene and graphene oxide;
c) forming a catalyst layer by applying a dispersion containing the non-platinum catalyst complex coated with the conductive polymer of the step a); and
d) forming a multilayer structure in which the graphene layer and the catalyst layer are alternately stacked by repeating the steps b) and c) two or more times, respectively.

15. The method of claim 14, wherein the step a) is performing drying at 60 to 150° C. and performing heat treatment at a temperature of 300 to 900° C.

16. The method of claim 14, wherein the space is formed between the graphene layer and the catalyst layer during the stacking of the step d).

17. The method of claim 14, wherein the application in the step b) or c) is performed by ultrasonic spray.

18. A membrane-electrode assembly for a fuel cell, comprising:
the fuel cell electrode according to claim 1; and
a polymer electrolyte membrane.

19. The membrane-electrode assembly of claim 18, wherein the fuel cell electrode is a cathode electrode.

20. A fuel cell comprising the membrane-electrode assembly for a fuel cell of claim 18.
